(19) United States
(12) Patent Application Publication
(10) Pub. No.: US 2016/0142665 A1
(43) Pub. Date: May 19, 2016

(54) VIDEO DISPLAY DEVICE

(71) Applicants: KABUSHIKI KAISHA TOSHIBA, Tokyo (JP); Toshiba Lifestyle Products & Services Corporation, Tokyo (JP)

(72) Inventors: Yoshiharu MOMONOI, Yokohama Kanagawa (JP); Tatsuo SAISHU, Kokubunji Tokyo (JP)

(21) Appl. No.: 15/007,457

(22) Filed: Jan. 27, 2016

Related U.S. Application Data
(63) Continuation of application No. PCT/JP2013/070809, filed on Jul. 31, 2013.

(51) Int. Cl. H04N 5/655; G02B 3/08

(52) U.S. Cl. CPC H04N 5/655; G02B 3/08

(57) ABSTRACT

According to one embodiment, a video display device comprising: a display comprising a video display module and a frame; an optical element; and a spacer member comprising a flat plate and a supporter, wherein an expression of “t1/t2=1/(2×n)” is established when a thickness of the supporter at a boundary of the flat plate and the supporter is denoted by t1, a distance between the boundary and the optical element is denoted by t2, and a refractive index of the flat plate is denoted by n.

### CROSS-REFERENCE TO RELATED APPLICATIONS

This application is a continuation of International Application No. PCT/JP2013/070809, filed on Jul. 31, 2013, the entire contents of which are incorporated herein by reference.

### FIELD

Embodiments described herein relate generally to a video display device.

### BACKGROUND

Conventionally, there has been known a technique to prevent viewers from visually recognizing outer frames of a display by enlarging video on the display using optical elements provided correspondingly to the outer frames. In such a technique, a spacer member may be provided between the display (and the outer frames) and the optical elements.

In the technique as described above, it is desirable to reduce the weight of the spacer member.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic view illustrating an example of a tiling display configured by combining a plurality of video display devices with each other, according to an embodiment;

FIG. 2 is an exemplary schematic view illustrating directions in which video is enlarged by a linear lens (optical element) of the video display device in the embodiment;

FIG. 3 is an exemplary schematic view illustrating directions in which video is enlarged by a circular lens (optical element) of the video display device in the embodiment;

FIG. 4 is an exemplary schematic view illustrating a positional relationship among a display, a frame, an optical element, and a spacer member of the video display device in the embodiment;

FIG. 5 is an exemplary schematic view illustrating how video output by the video display device is viewed, in the embodiment;

FIG. 6 is an exemplary schematic enlarged view illustrating a boundary of a flat plate and a supporter of the spacer member of the video display device in the embodiment;

FIG. 7 is an exemplary schematic view illustrating an example of a tiling display configured by combining a plurality of video display devices with each other, according to a first modification of the embodiment;

FIG. 8 is an exemplary schematic view illustrating an example in which an optical element and a spacer member are integrated with each other in a video display device according to a second modification of the embodiment;

FIG. 9 is an exemplary schematic view illustrating an example of an optical element of a video display device according to a third modification of the embodiment;

FIG. 10 is an exemplary schematic view illustrating an example in which a supporter is made of a transparent material in a video display device according to a fourth modification of the embodiment; and

FIG. 11 is an exemplary schematic view illustrating an example in which a supporter is made with a non-transparent material in a video display device according to a fifth modification of the embodiment.

### DETAILED DESCRIPTION

In general, according to one embodiment, a video display device comprising: a display comprising a video display module configured to display video, and a frame provided on an outer edge of the video display module; an optical element provided to cover the frame and an outer edge area, and configured to enlarge video output from the outer edge area onto the frame side, the outer edge area being provided on the outer edge side within the video display module; and a spacer member provided between the video display module and the optical element and between the frame and the optical element, the spacer member comprising a flat plate and a supporter, the flat plate being provided to cover the video display module while being separated from the video display module by a space, the supporter being provided to support the flat plate, wherein an expression of “t1/t2=1/(2×n)” is established when a thickness of the supporter at a boundary of the flat plate and the supporter is denoted by t1, a distance between the boundary and the optical element is denoted by t2, and a refractive index of the flat plate is denoted by n.

Embodiments will be described below based on the drawings.

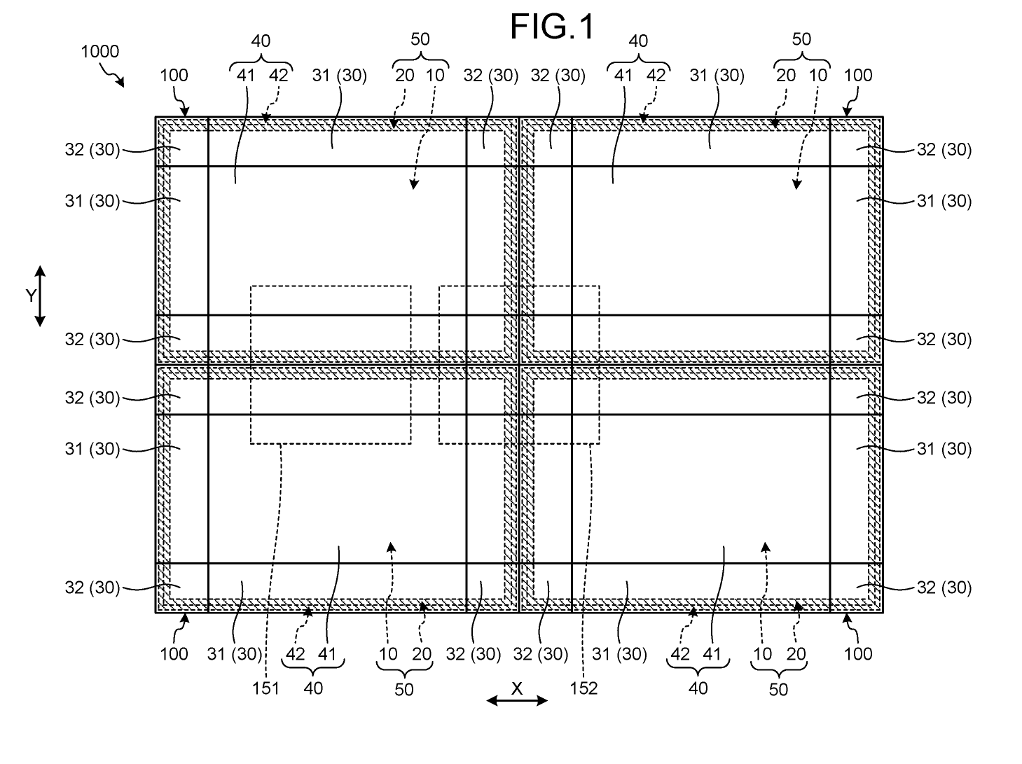

With reference to FIG. 1 to FIG. 6, an exemplary configuration of a video display system (a tiling display 1000) comprising a plurality of video display devices 100 combined with each other according to an embodiment will be described.

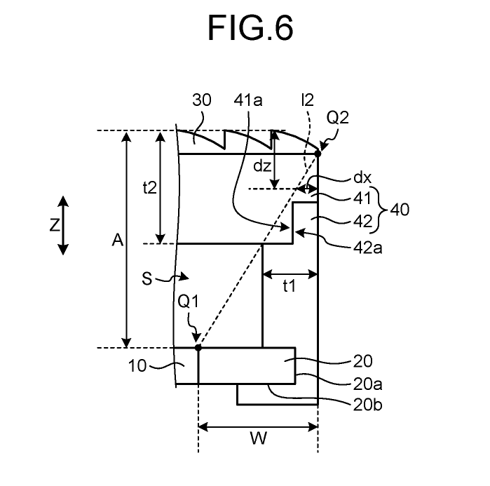

As illustrated in FIG. 1, the tiling display 1000 according to the embodiment comprises four video display devices 100, two each being arranged in the horizontal direction (the X direction) and the vertical direction (the Y direction) in a tile pattern. Each of the four video display devices 100 comprises a video display module 10, a frame 20, an optical element 30, and a spacer member 40. The video display module 10 has a quadrilateral shape and is configured to be able to output video, such as a moving image or a still image. The frame 20 is provided so as to surround an outer periphery (an outer edge: see a point Q1 in FIG. 6 to be described later) of the video display module 10 (see hatching with oblique lines in FIG. 1) and to extend along four sides of the video display module 10. A display (display panel) 50 is configured with the video display module 10 and the frame 20.

In the video display device 100 comprising the video display module 10 and the frame 20 as described above, it is desired to prevent the frame 20 from being viewed by a viewer. For example, when a single large piece of video is displayed by using the tiling display 1000 as illustrated in FIG. 1, it is desired to prevent a cross-shaped joint, which is composed of the frames 20 provided on the inside of the tiling display 1000 (boundaries of the video display devices 100), and a quadrilateral outer frame, which is composed of the frames 20 provided on the outside of the entire tiling display 1000, from being viewed by the viewer.

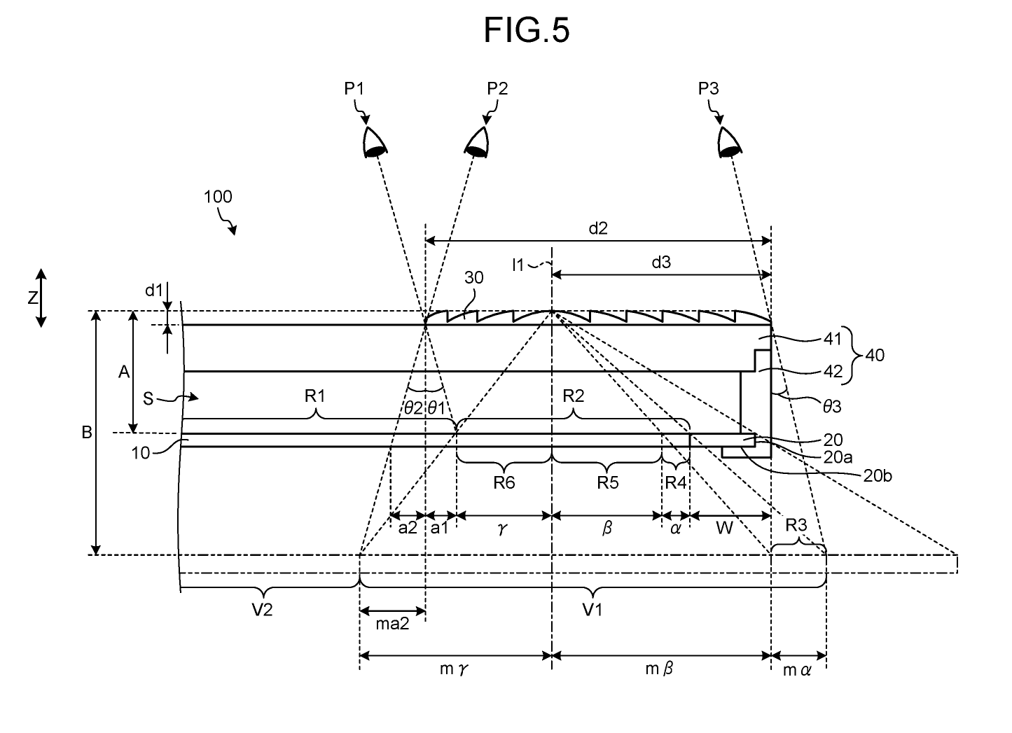

Therefore, in the embodiment, the optical element 30 is provided, which covers the frame 20 and an outer peripheral area (an outer edge area: see a reduction area R2 in FIG. 5 to be described later) provided on the outer periphery (the outer edge: a boundary with respect to the frame 20) side within the video display module 10. The optical element 30 enlarges the video output from the outer peripheral area, thereby preventing the frames 20 from being viewed by the viewer. This enables the tiling display 1000 comprising the four video display devices 100 to function as a continuous single display. Namely, the video display module 10 is configured to output video reduced at a reduction ratio corresponding to a magnification of the optical element 30 onto the outer peripheral area, and the optical element 30 is configured to enlarge the video (reduced video) output from the outer peripheral area of the video display module 10 to at least the frame 20 side.

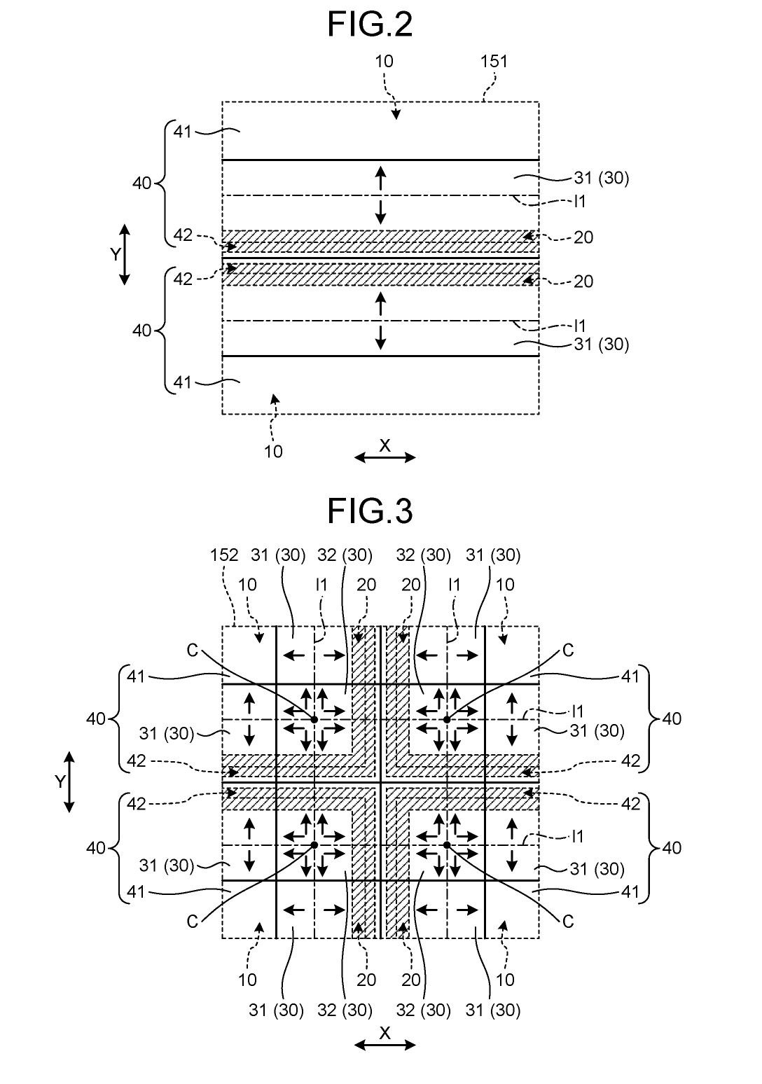

The optical element 30 comprises a combination of linear lenses 31 and circular lenses 32. The linear lenses 31 are provided so as to extend along the four sides of the video display module 10, and have rectangular shapes for example. The linear lenses 31 are configured to enlarge video output from the outer peripheral area of the video display module 10 in only one direction of the X direction or the Y direction (see the arrows in FIG. 2). The circular lenses 32 are provided at four corners of the video display module 10, and have rectangular shapes or square shapes for example. The circular lenses 32 are configured to enlarge video output from the outer peripheral area of the video display module 10 in two directions of the X direction and the Y direction (see the arrows in FIG. 3).

As illustrated in FIG. 2, the linear lens 31 has an optical axis 11 extending along a side of the video display module 10, and is configured to enlarge video output from the outer peripheral area in a line symmetric manner with respect to the optical axis 11. Incidentally, FIG. 2 is a schematic enlarged view of a quadrilateral portion 151 located on one side in the X direction (the left side in FIG. 1) and near a central portion in the Y direction of the tiling display 1000 as illustrated in FIG. 1.

Furthermore, as illustrated in FIG. 3, the circular lens 32 has a center C at which two optical axes 11 corresponding to the two adjacent linear lenses 31 cross each other, and is configured to enlarge video output from the outer peripheral area in a point symmetric manner with respect to the center C. Incidentally, FIG. 3 is a schematic enlarged view of a quadrilateral portion 152 located near a central portion in the X direction and the Y direction of the tiling display 1000 as illustrated in FIG. 1.

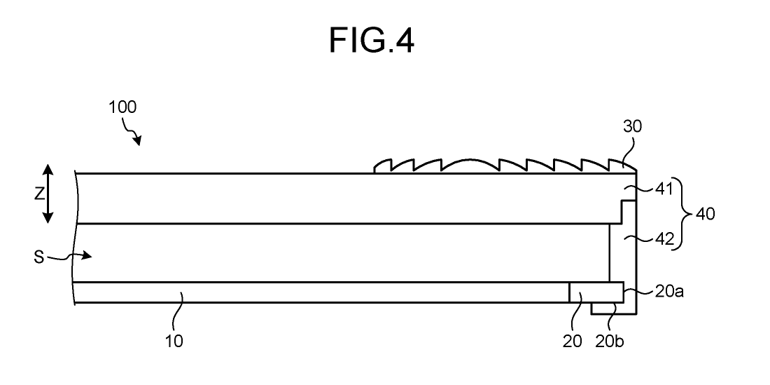

In the embodiment, the optical element 30 (the linear lenses 31 and the circular lenses 32) is provided so as to extend parallel to a flat plate 41 of the spacer member 40 (see FIG. 4 and FIG. 5) to be described later. More specifically, the linear lens 31 comprises a Fresnel-shaped lens notched in a line symmetric manner with respect to the optical axis 11 (see FIG. 2). Similarly, the circular lens 32 comprises a Fresnel-shaped lens notched in a point symmetric manner (in a concentric manner) with respect to the center C (see FIG. 3). Using the Fresnel-shaped lenses as described above for the optical element 30 allows a thickness d1 of the optical element 30 (see FIG. 5) to be made smaller than in ordinary convex lenses.

Furthermore, in the embodiment, as illustrated in FIG. 4 to FIG. 6, the spacer member 40 is provided between each of the video display module 10 and the frame 20, and the optical element 30. The spacer member 40 is provided to maintain a predetermined distance between the video display module 10 (the frame 20) and the optical element 30. The spacer member 40 comprises the flat plate 41 and a supporter 42.

The flat plate 41 is provided so as to cover the video display module 10 while being separated from the video display module 10 by a space (an air layer made of air) S. Further, the flat plate 41 is provided so as to extend parallel to the video display module 10. The supporter 42 is provided so as to support an end of the flat plate 41 on the frame 20 side. Further, the supporter 42 is provided so as to extend perpendicular to the flat plate 41.

As illustrated in FIG. 1, the flat plate 41 has a quadrilateral shape grater than the video display module 10. The supporter 42 is provided so as to extend along an outer periphery (four sides) of the quadrilateral flat plate 41. Both of the flat plate 41 and the supporter 42 are made of a transparent material.

With reference to FIG. 5, how video output from the video display device 100 in the embodiment is viewed will be described below. As illustrated in FIG. 5, the video display module 10 of the video display device 100 has a normal area R1 and the reduction area (outer peripheral area) R2. In the normal area R1, normal video that is neither enlarged nor reduced is output. In the reduction area R2, reduced video which is video reduced at a reduction ratio corresponding to a magnification of the optical element 30 is output. The Chain double-dashed line in FIG. 5 represents video (virtual video) visually recognized by a viewer via the optical element 30.

As illustrated in FIG. 5, the optical element 30 (with a magnification m) is configured to enlarge the reduced video output from the reduction area R2 as a virtual video V1 with a greater width than the optical element 30. In the embodiment, a width (a+(3+y) of the reduction area R2 is smaller than an entire length d2 of the optical element 30. Therefore, even when a viewer looks into the video display device 100 from a viewpoint P1, which is on the inside at an angle 81 relative to an inner end (on the side opposite to the frame 20) of the optical element 30, the viewer visually recognizes normal video (the normal area R1) rather than the reduced video (the reduction area R2) , so that it is possible to prevent the viewer from feeling discomfort.

Furthermore, in the embodiment, a width (m×(α+β+γ)) of the virtual video V1 corresponding to the reduction area R2 is greater than the entire length d2 of the optical element 30. Therefore, even when a viewer views the video display device 100 from a viewpoint P2 which is on the outside (on the frame 20 side) at an angle 02 relative to the inner end of the optical element 30, the viewer visually recognizes video (the virtual video V1) enlarged from the reduced video (the reduction area R2) rather than video (a virtual video V2) enlarged from the normal video (the normal area R1), so that it is possible to prevent the viewer from feeling discomfort.

Moreover, in the embodiment, the virtual video V1 has an area R3 protruding outward relative to an outer end (on the frame 20 side) of the video display device 100. In an area R4, which is a part of the reduction area R2 and corresponds to the area R3, video (overlapping video) that overlaps video displayed near an end of the adjacent video display device 100 on the frame 20 side is output in a reduced state. Hereinafter, the area R4 is referred to as an overlapping area. By the above-described configuration, even when a viewer views the tiling display 1000 comprising a plurality of the video display devices 100 (see FIG. 1), the viewer can visually recognize the overlapping video in the area R3, so that it is possible to prevent the viewer from feeling discomfort at the boundaries of the video display devices 100. Namely, even when the viewer views the video display device 100 from the viewpoint P3, which is on the inside (on the side opposite to the frame 20) at an angle θ3 relative to an outer end of the optical element 30, the viewer can visually recognize non-defective video.

An example of an optical system that allows a viewer to visually recognize non-defective video will be described in detail below with reference to Expressions.

First, assuming that a length of an outer portion (on the frame 20 side) of the the optical element 30 relative to the optical axis 11 is denoted by d3, the magnification m of the optical element 30 is represented by Expression (1) below based on a length R of an area R5 which is an outer area of the reduction area R2 excluding the overlapping area R4 relative to the optical axis 11.

m=d3/β (1)

Assuming that a width of the frame 20 (a width of the frame 20 and a part of the supporter 42 that covers an outer surface 20a of the frame 20) is denoted by W and a length of the overlapping area R4 is denoted by α, the above described length d3 for preventing the viewer from visually recognizing the frame 20 (for causing the viewer to visually recognize the virtual video V1 that is to cover the optical element 30) is represented by Expression (2) below.

d3=β+α+W (2)

In this case, if a condition of d3=m×β is satisfied for example, the frame 20 is not visually recognized at least when viewed from the front side (on one side in the Z direction: from above in FIG. 5). In the embodiment, the overlapping area R4 with the length α is provided, so that it is possible to allow the viewer to visually recognize non-defective video at up to the viewpoint P3 which is on the inside (on the side opposite to the frame 20) at the angle θ3 relative to the outer end of the optical element 30.

Furthermore, assuming that a focal length of the optical element 30 is denoted by f, a distance A between the video display module 10 and the optical element 30 is represented by Expression (3) below.

A=f((β/d3)−1)=f(1/m−1) (3)

In this case, a distance B at which the virtual video V1 is visually recognized is represented by Expression (4) below.

B=A(d3/β)=m×A (4)

In this case, the angle θ3 at which the above-described overlapping area R4 is visually recognized is represented by Expression (5) below.

tan(θ3)=−(α/B)×(d3/β)=−(α/B)×m (5)

If a condition of |θ3|=|θ2|=|θ1| is satisfied, a relationship between a width a1 of a portion provided on the back side of the optical element 30 and a width a2 of a portion adjacent to the portion with the width a1 in the normal area R1 is represented by Expression (6) below.

||a1|=|a2| (6)

A relationship between the widths a1, a2, and a length γ of an area R6, which is on the inside (on the side opposite to the frame 20) relative to the optical axis 11 of the reduction area R2, is represented by Expression (7) below.

|m|×γ=γ+a1+|m|×a2=γ+a1+|m|×a1 (7)

Furthermore, a relationship represented by Expression (8) below is established between the above described width a1, and the distance A between the optical element 30 and the video display module 10.

|a1|=|A|×tan|θ1|=|A|tan|θ3| (8)

Consequently, Expression (9) below is derived from Expression (7) and Expression (8) described above.

γ=|A|×tan|θ3|×(1+|m|)/(|m|−1) (9)

According to Expression (9) as described above, it is possible to calculate the length γ of the area R6 on the inside relative to the optical axis 11 in the reduction area R2, which allows the viewer to visually recognize non-defective video when the viewer views the video display device 100 from the viewpoint P3 (P1, P2) at the angle θ3 (θ1, θ2).

An exemplary configuration (shape) of the spacer member 40 (the flat plate 41 and the supporter 42) of the video display device 100 in the embodiment will be described in detail below with reference to FIG. 6.

As illustrated in FIG. 6, the flat plate 41 and the supporter 42 are connected to each other at a position on the frame 20 side relative to an optical path (see a line 12) connecting the outer periphery (see the point Q1) of the video display module 10 and the outer end (the end on the frame 20 side; see a point Q2) of the optical element 30. Specifically, an end of the flat plate 41 on the frame 20 side and an end of the supporter 42 on the flat plate 41 side comprise stepped portions 41a and 42a in matching shapes, respectively. The stepped portions 41a and 42a are fitted to each other, so that the flat plate 41 and the supporter 42 are connected to each other. Therefore, in the embodiment, even when the viewer views the video display device 100 from the outer end side of the optical element 30 toward the outer periphery of the video display module 10, a line of sight of the viewer can be prevented from being blocked by the connected portion of the flat plate 41 and the supporter 42, so that it is possible to prevent the viewer from feeling discomfort.

Furthermore, in the embodiment, the supporter 42 is formed in a shape so as not to protrude toward the side opposite to the frame 20 relative to the optical path (see the line 12) connecting the outer periphery of the video display module 10 and the end of the optical element 30 on the frame 20 side. Therefore, it is possible to prevent the supporter 42 from blocking light traveling from the outer periphery of the video display module 10 toward the outer end of the optical element 30, so that it is possible to prevent the viewer from feeling discomfort. In the embodiment, the supporter 42 is mounted on the frame 20 so as to cover the outer surface 20a of the frame 20. The supporter 42 may be fixed to the outer surface 20a of the frame 20 or may be fixed to a back surface 20b of the frame 20.

With reference to FIG. 6, an example of the spacer member 40 that prevents a viewer from feeling discomfort will be described in detail below with reference to Expressions.

It is assumed that a thickness of the supporter 42 at a boundary of the flat plate 41 and the supporter 42 (a portion in which the stepped portions 41a and 42a are fitted to each other) is denoted by t1, and a distance between the boundary of the flat plate 41 and the supporter 42 and the optical element 30 (a thickness of the flat plate 41 including the optical element 30) is denoted by t2. In this case, assuming that a refractive index of the flat plate 41 is denoted by n, an optical distance corresponding to the thickness t2 of the flat plate 41 including the optical element 30 is represented by (t2/n). A relationship between the thickness t1 and the optical distance (t2/n) is represented by Expression (10) below based on a similarity relation.

(t2/n):t1=A:W (10)

To prevent the supporter 42 from blocking light travelling from the outer periphery of the video display module 10 toward the outer end of the optical element 30, the supporter 42 needs to be provided on the frame 20 side relative to the optical path (see the line 12) connecting the outer periphery of the video display module 10 and the end of the optical element 30 on the frame 20 side. Therefore, with respect to the thickness t1 of the supporter 42, a condition represented by Expression (11) below needs to be satisfied based on Expression (10) described above.

t1<(t2×W)/(n×A) (11)

Furthermore, assuming that an optical distance from the surface of the optical element 30 is denoted by dz, a distance dx between the optical path (see the line 12), which connects the outer periphery of the video display module 10 and the end of the optical element 30 on the frame 20 side, and the outer end (the end on the frame 20 side) of the video display device 100 is represented by Expression (12) below based on Expression (10) described above.

dx=dz×(W/A) (12)

Therefore, to prevent the spacer member 40 (the flat plate 41 and the supporter 42) from blocking light travelling from the outer periphery of the video display module 10 toward the outer end of the optical element 30, the spacer member 40 needs to be configured by using a transparent material for at least a portion of the spacer member 40 in which the distance from the outer end of the video display device 100 (on the frame 20 side) is greater than dx (=dz×(W/A)) described above.

Next, a relational expression between the thickness t1 of the supporter 42 and the thickness t2 of the flat plate 41 will be described from a different perspective.

In general, a relationship between a curvature radius r and a focal distance f of a plano-convex lens (with a refractive index n) is represented by Approximate Expression (13) below.

f=r/(n−1) (13)

If approximation with n=1.5 is performed in Expression (13) described above, Expression (14) below is derived.

r≈f/2 (14)

According to Expression (14) as described above, it is found that the maximum value of the curvature radius r of the lens with n=1.5 is about a half of the focal distance f.

In the embodiment, the maximum value of the length d3 of the outer portion (the portion on the frame 20 side) of the optical element 30 relative to the optical axis 11 can be assumed as the curvature radius of the optical element 30. Therefore, Expression (15) below is established based on Expression (14) described above.

f≈2×d3 (15)

With Expression (15) and Expressions (1) to (3) as described above, Expressions (16) to (19) below are derived.

A≈2((d3/m)−d3) (16)

A≈2(β−(β+α+W)) (17)

≈−2(α+W) (18)

|A|≈2(α+W) (19)

If A is substituted with the optical thickness (t2/n) of the flat plate 41 (with the refractive index n) in Expression (19) described above, Expression (20) below is established under the condition that the thickness t1 of the supporter 42 is smaller than the width W of the frame 20.

t1<(t2/(2×n)−α (20)

If the overlapping area R4 is not provided (in other words, the width α of the overlapping area R4 is zero) as a minimum condition to prevent a viewer from feeling discomfort, Expression (20) described above is represented by Expression (21) below.

t1<(t2/(2×n))−α (21)

Expression (21) described above is a conditional expression for the case when the length d3 of the outer portion of the optical element 30 relative to the optical axis 11 is equal to the curvature radius (f=2×d3). Therefore, if d3 is reduced, the coefficient of 2 on d3 becomes greater than 2, so that the thickness t1 of the supporter 42 is further reduced. That is, a value of the right side of Expression (21) described above is the maximum value of the thickness t1 of the supporter 42 when the refractive index n of the flat plate 41 is approximated by 1.5. If the refractive index n of the flat plate 41 is approximated by 1.5 in Expression (21) described above, Expression (22) below is established.

t1<t2/3 (22)

According to Expression (22) as described above, it is found that the thickness t1 of the supporter 42 at the boundary of the flat plate 41 and the supporter 42 needs to be set to equal to or smaller than one-third of the distance t2 between the boundary and the optical element 30 (the thickness of the flat plate 41 including the optical element 30).

As described above, in the embodiment, the spacer member 40 is provided between the video display module 10 (the frame 20) and the optical element 30, and the spacer member 40 comprises the flat plate 41, which is provided so as to cover the video display module 10 while being separated from the video display module 10 by the space S, and the supporter 42, which is provided so as to support the flat plate 41. Therefore, for example, unlike the case in which a space between the video display module 10 (the frame 20) and the optical element 30 is filled with resin or the like, it is possible to reduce the weight of a member (the spacer member 40) that maintains a distance between the video display module 10 (the frame 20) and the optical element 30.

Furthermore, in the embodiment, by providing the space S between the video display module 10 (the frame 20) and the spacer member 40 as described above, for example, the entire thickness of the video display device 100 can be reduced. This exemplary effect will be described in detail below, with reference to Expressions.

For example, if the entire space between the optical element 30 and the video display module 10 is filled with resin with a refractive index n, an optical distance t3 from the video display module 10 to the optical element 30 (the entire thickness of the video display device 100) is represented by Expression (23) below with the distance A between the video display module 10 and the optical element 30.

t3=|A|×n (23)

In contrast, as in the embodiment, if the space S with a thickness t4 is provided between the optical element 30 (the flat plate 41) and the video display module 10, an entire thickness t5 of the video display device 100 is represented by Expression (24) below.

t5=t4+(|A|−t4)×n (24)

Therefore, a difference Δ in the entire thickness of the video display device 100 by comparison between the embodiment and the case in which the entire space between the optical element 30 and the video display module 10 is filled with resin with the refractive index n is represented by Expression (25) below.

Δ=t4−t3=t4(n−1) (25)

In general, the refractive index n of the flat plate 41 is greater than 1. Therefore, the value Δ of the left side of Expression (25) described above is always greater than zero unless the thickness t4 of the space S is set to zero. This represents an exemplary effect to reduce the entire thickness of the video display device 100 in the embodiment.

In the above embodiment, an exemplary case in which the technology is applied to a tiling display comprising four video display devices is described. However, the technology of the embodiment is applicable to a video display device used as a single unit. The technology of the embodiment is also applicable to a tiling display comprising two or more but three or less video display devices and a tiling display comprising five or more video display devices.

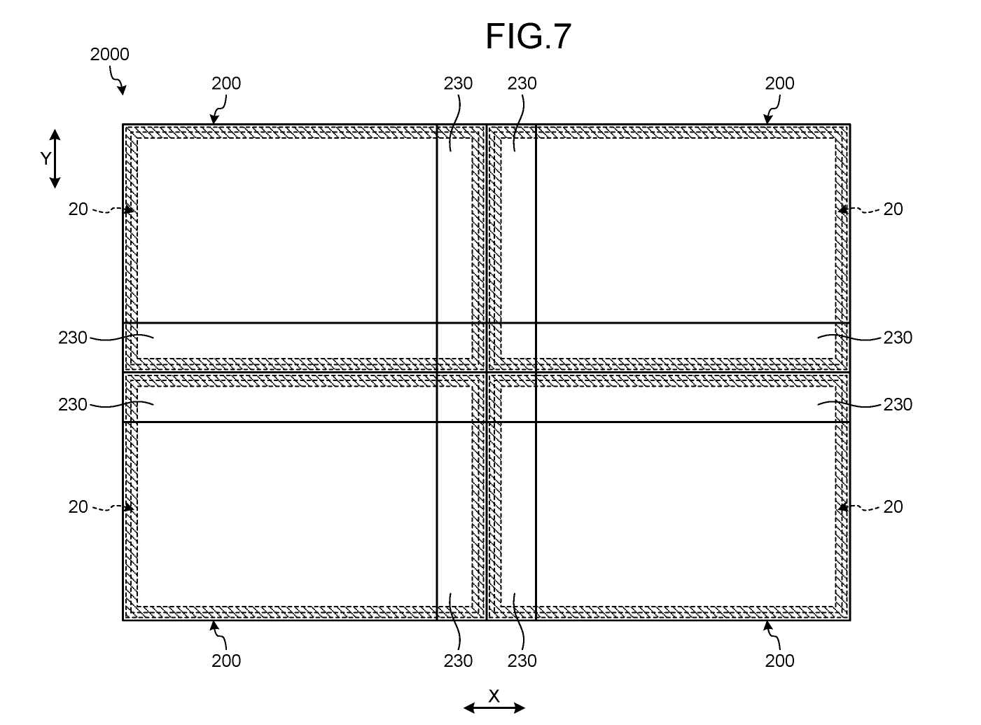

Furthermore, in the above embodiment, an exemplary case in which the optical element is provided on each of the four sides of each of the four video display devices is described; however, the embodiment is not limited thereto. As in a first modification of the embodiment illustrated in FIG. 7, an optical element 230 may be provided only at a boundary between two adjacent video display devices 200 of a tiling display 2000 comprising four video display devices 200. In the first modification, the frames 20 provided at the inner cross-shaped portion of the tiling display 2000 are less easily visually recognized, while the frames 20 provided at a quadrilateral outer portion of the tiling display 2000 are easily visually recognized.

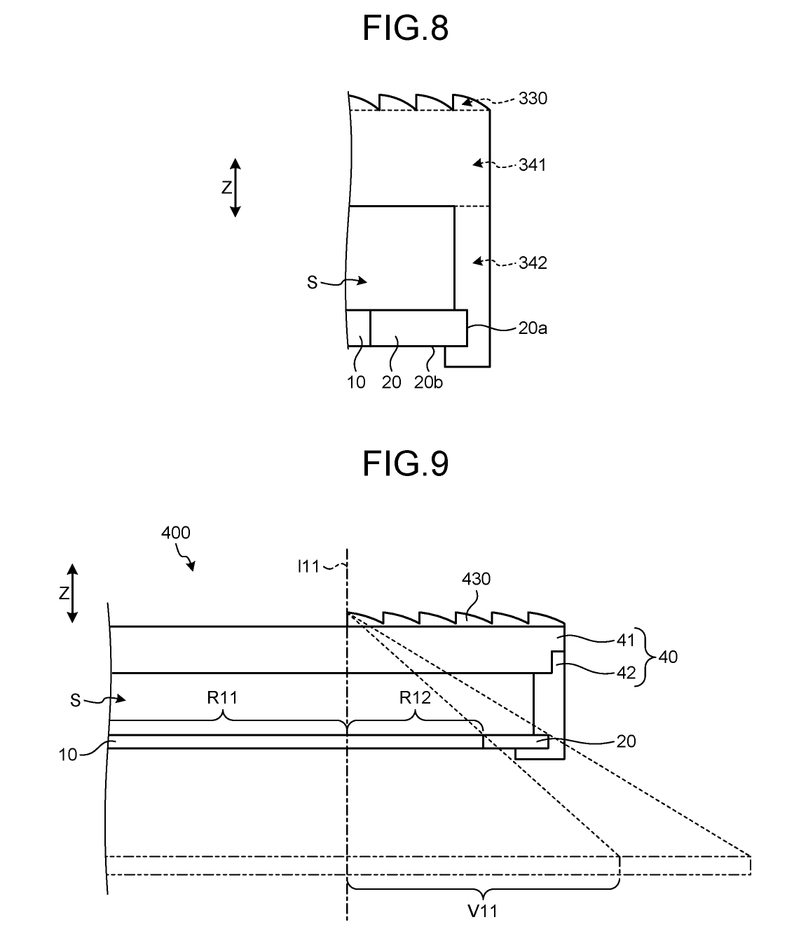

Moreover, in the above embodiment, an exemplary case in which the optical element and the spacer member are formed separately from each other is described. However, in a modification of the embodiment, the optical element and the spacer member may be integrally formed. Similarly, in the above embodiment, an exemplary case in which the flat plate and the supporter of the spacer member are formed separately from each other is described. However, in a modification of the embodiment, the flat plate and the supporter may be integrally formed. That is, as in a second modification of the embodiment illustrated in FIG. 8, a part 330 that functions as the optical element, a part 341 that functions as the flat plate and a part 342 that functions as the supporter may be integrally formed.

Furthermore, in the above embodiment, an exemplary case in which the optical element comprises the linear lenses and the circular lenses combined with each other is described. However, in a modification of the embodiment, any other optical system may be used.

Moreover, in the above embodiment, an exemplary case in which the optical element extends on both sides (the frame side and the side opposite to the frame) relative to the optical axis is described. However, as in a third modification illustrated in FIG. 9, an optical element 430 without a portion that extends on the side opposite to the frame 20 relative to an optical axis 111 may be employed. In the third modification, the optical element 430 does not cover a normal area R11 of the video display module 10 but covers the frame 20 and a reduction area R12.

In the third modification illustrated in FIG. 9, similarly to the above embodiment, the frame 20 overlaps a virtual video V11 that is formed by a reduced image output in the reduction area R12 being enlarged by the optical element 430, so that the frame 20 can be prevented from being visually recognized by a viewer. Furthermore, in the third modification, similarly to the above embodiment, the flat plate 41 of the spacer member 40 provided between the optical element 430 and the video display module 10 (the frame 20) is provided so as to be separated from the video display module 10 by the space S. Therefore, in the third modification, similarly to the above embodiment, it is possible to reduce the weight of the spacer member 40, and reduce the entire thickness of a video display device 400 (the thickness in the Z direction).

Moreover, in the above embodiment, an exemplary case in which the flat plate and the supporter of the spacer member are made of a transparent material is described; however, the embodiment is not limited thereto. In the embodiment, if a portion provided on the side opposite to the frame relative to a line connecting the outer periphery of the display module and the end of the optical element on the frame side is made of a transparent material, it is possible to prevent the spacer member from blocking light travelling from the outer periphery of the display module toward the end of the optical element on the frame side. Therefore, in the embodiment, for example, the supporter provided on the side opposite to the frame relative to the line connecting the outer periphery of the display module and the end of the optical element on the frame side may be made of a non-transparent material (an opaque material), such as a metal, instead of a transparent material.

To prevent the viewer from feeling discomfort both when the supporter is made with a transparent material and when the supporter is made with a non-transparent material, the thickness of the supporter at the boundary of the flat plate and the supporter needs to be set to equal to or smaller than one-third of a distance between the boundary and the optical element.

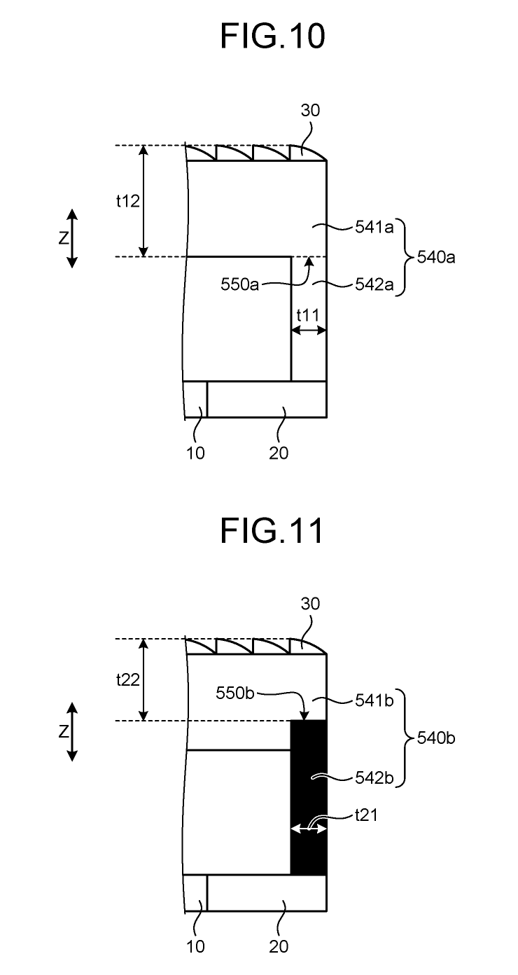

For example, in a fourth modification illustrated in FIG. 10, a spacer member 540a comprises a part 541a that functions as the flat plate and a part 542a that functions as the supporter, in an integrated manner. Both of the parts 541a and 542a are made of a transparent material. In the fourth modification, a thickness t11 of the part 542a at a boundary 550a of the part 541a and the part 543a needs to be set to equal to or smaller than one-third of a distance t12 between the boundary 550a and the optical element 30 (a thickness of the part 541a including the optical element 30).

Furthermore, in a fifth modification illustrated in FIG. 11, a spacer member 540b comprises a flat plate 541b made of a transparent material and a supporter 542b made of a non-transparent material. In the fifth modification, a thickness t21 of the supporter 542b at a boundary 550b of the flat plate 541b and the supporter 542b needs to be set to equal to or smaller than one-third of a distance t22 between the boundary 550b and the optical element 30 (a thickness from the surface of the optical element 30 to the boundary 550b).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A video display device comprising:
a display comprising a video display module configured to display video, and a frame provided on an outer edge of the video display module;
an optical element provided to cover the frame and an outer edge area, and configured to enlarge video output from the outer edge area onto the frame side, the outer edge area being provided on the outer edge side within the video display module; and
a spacer member provided between the video display module and the optical element and between the frame and the optical element, the spacer member comprising a flat plate and a supporter, the flat plate being provided to cover the video display module while being separated from the video display module by a space, the supporter being provided to support the flat plate, wherein
an expression of “t1/t2=1/(2×n)” is established when a thickness of the supporter at a boundary of the flat plate and the supporter is denoted by t1, a distance between the boundary and the optical element is denoted by t2, and a refractive index of the flat plate is denoted by n.

2. The video display device of claim 1, wherein the flat plate and the supporter are connected to each other at one of a position on an optical path and a position on the frame side relative to the optical path, the optical path connecting the outer edge of the video display module and an end of the optical element on the frame side.

3. The video display device of claim 1, wherein the supporter has a shape not to protrude toward a side opposite to the frame relative to an optical path connecting the outer edge of the video display and an end of the optical element on the frame side.

4. The video display device of claim 1, wherein portions of the flat plate and the supporter are made of a transparent material, the portions being provided on a side opposite to the frame relative to an optical path connecting the outer edge of the video display module and an end of the optical element on the frame side.

5. The video display device of claim 1, wherein the video display module is configured to output video reduced at a reduction ratio corresponding to a magnification of the optical element onto the outer edge area.

6. The video display device of claim 1, wherein the optical element and the flat plate are provided integrally.

7. The video display device of claim 1, wherein the flat plate and the supporter are provided integrally.

8. The video display device of claim 1, wherein the supporter is mounted on the frame to cover an outer surface of the frame.

9. The video display device of claim 1, wherein the optical element comprises a Fresnel lens extending parallel to the display on the flat plate.
